(19) United States
(12) Patent Application Publication
(10) Pub. No.: US 2003/0079903 A1
(43) Pub. Date: May 1, 2003

(54) Cable with an external extruded sheath and method of manufacturing of the cable

(75) Inventors: Ralf Scheidecker, Geisa (DE); Horst Reinhard, Hauneck (DE); Peter Schwirblies, Bad Hersfeld (DE); Hal Armstrong, Fergus (CA); Hal Aitken, Rockwood (CA)

Correspondence Address: SUGHRUE MION, PLLC, 2100 Pennsylvania Avenue, NW, Washington, DC, 20037-3213, US

(73) Assignee: NEXANS

(21) Appl. No.: 10/273,845

(22) Filed: Oct. 21, 2002

(30) Foreign Application Priority Data
Oct. 22, 2001 (EP) 01402742.9

(51) Int. Cl. H01B 7/00

(52) U.S. Cl. 174/110 F

(57) ABSTRACT

A cable is described, the core of which is surrounded by an external extruded sheath. The core of the cable comprises at least one transmission element for the transmission of electrical current or telecommunication signals. The sheath (M) comprises at least one flexible layer (2) of a conventional, expanded material, this material having a tensile strength between 10.0 MPa and 50.0 MPa.

### DESCRIPTION

The invention is concerned with a cable the core of which is surrounded by an external extruded sheath, which core comprises at least one transmission element for the transmission of electrical current or telecommunication signals. The invention also is concerned with a method of manufacturing of such a cable.

The word “cable” also stands for the word “line”. “Cable” can be an electrical or optical cable with any design of the core which is surrounded by a sheath of insulating material. “Transmission elements” can be metallic electrical conductors or optical waveguides. Such cables have a protective outer sheath of insulating material with different characteristics depending on the type of the cable and the field of use of the same. The thickness of the sheath is variable depending on the mentioned characteristics. The amount of material for forming the sheath of such cables normally is high. The portion of the sheath to the weight of the complete cable is considerable.

WO 98/52197 describes a power transmission cable with an outer coating made of expanded polymer material. The coating shall be capable of protecting the cable from accidental impacts. A separate metal armor shall not be needed. The coating therefore has special mechanical characteristics to absorb impacts. The used material has a degree of expansion from 20% to 3000% and a flexural modulus between 400 MPa and 1800 MPa. Such a material is expensive. Its weight is lower compared to the not expanded version. But for the purpose of impact protection the coating of expanded polymer material needs an adequate thickness and flexural modulus together with a great mass. Therefrom the weight of the sheath still is high. Such a coating therefore only is usefull with cables which normally have a metal armor and then can be manufactured without such an armor.

WO 98/52197 also mentions documents which describe cables for the transmission of signals with a layer of expanded insulating material. Such a material shall be usefull only for the increase of the transmission speed of the signals. A hint for impact protection shall not to be find in these documents.

From GB specification 1 339 561 an electrical cable is known preferably a telecommunication cable which also shall be protected against mechanical stresses like impacts without a special armoring. The core of the cable is surrounded by a layer of expanded insulating material which is surrounded by a layer of not expanded insulating material. The expanded layer has a greater thickness then the not expanded layer. This known cable is comparable with the cable of WO 98/52197.

It is an object of the invention to provide a cable an a corresponding method of production with a reduced weight and a reduced amount of extruded material for the outer sheath with normally used materials while its core design is maintained.

According to the invention the sheath comprises at least one flexible layer of a conventional, expanded material, this material having a tensile strength between 10.0 MPa and 50.0 MPa.

Such a cable has a lower weight than a cable with the same core, because the sheath with the same thickness is lighter depending on the enclosed gas bubbles. From the same reason the amount of sheathing material is reduced and the complete cable is more cost effective. Because of the reduced amount of sheathing material the incendiary load is reduced with an also reduced danger for the environment. In case of fire the amount of smoke and the heat release also are reduced. A special advantage of this cable is the fact that for its manufacturing conventional materials can be used without special treatment. It is not necessary to consider a high transmission speed for signals and an increased impact resistance also is not needed. The sheath of the cable only must guarantee the protection of the enclosed core also then when the cable is drawn under increased forces.

The cable can be manufactured in conventional technique with unchanged designs of the core. The sheath also can be applied in conventional technique by extrusion. A chemical blowing agent can be added to the material before extrusion. It also is possible to use the method of gasinjection for expanding the sheathing material without chemical additives.

The cable of the invention in a prefered embodiment is a house wiring cable, which is installed in buildings for illumination purposes and for power supply of electrical devices. Such cables are used in great volumes all over the world. The advantages of the invention are extremly interesting with such cables. That is true not only for weight and amount of sheathing material but especially for the low incendiary load and the reduced formation of smoke and release of heat.

More advantages of the invention are mentioned in the subclaims.

Examples of and prefered embodiments of the invention are shown in the drawings, wherein:

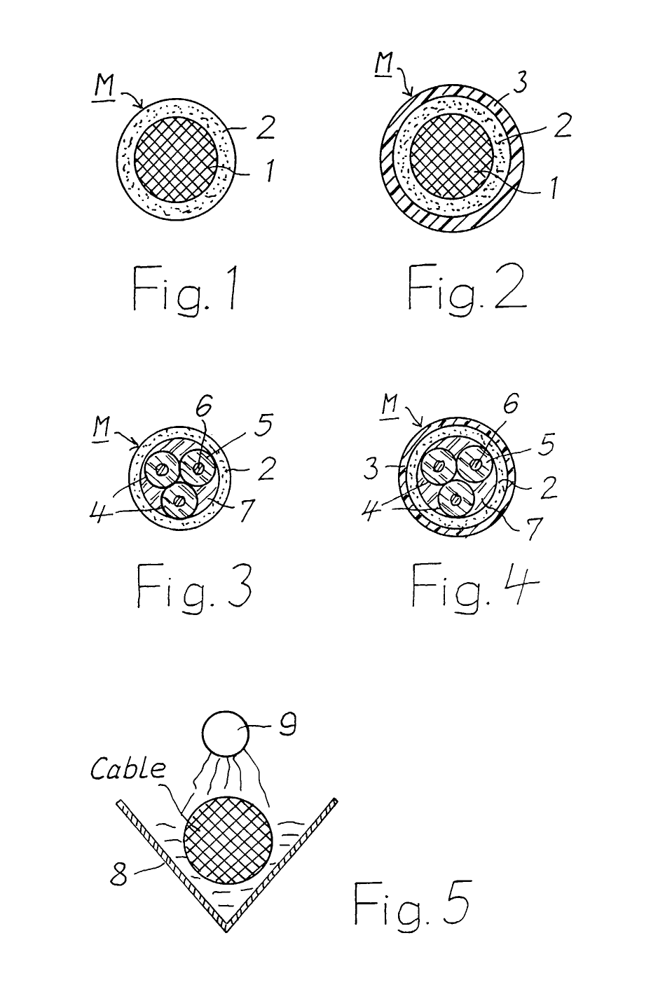

FIG. 1 is a schematic crossection of the cable of the invention with any design of the core.

FIG. 2 is a crossection of the cable of FIG. 1 with an additional feature.

FIGS. 3 and 4 are crossections of two different house wiring cables.

FIG. 5 is a schematic view of a cooling trough.

The cable of FIG. 1 can be e.g. a power cable, a medium voltage cable or a telecommunication cable with electrical or optical conductors. The design of the core 1 depends on the type of cable. The core 1 is shown with crosshatching and not more detailed because a special design here is not of interest. It is surrounded by a sheath M comprising one layer of an expanded sheathing material. The thickness of the sheath M is variable. It depends on the type of cable. It can e.g. ly between 1.4 mm and 2.2 mm.

Any material can be used for the sheath M. But it is necessary that the material of the sheath M can not hinder the flexibility of the cable and the tensile strength of the same must be between 10.0 MPa and 50.0 MPa, to guarantee the demanded function of protection. In a prefered embodiment a Polyvinylchloride comprising a plasticizer is used for the sheath M, that means a relatively soft and flexible Polyvinylchloride. It also is possible to use e.g. Polyethylene, Polypropylene or Polyurethane as sheathing material.

According to FIG. 2 the sheath M additionally can comprise a layer 3 of not expanded sheathing material which surrounds the layer 2 of expanded sheathing material. Both layers 2 and 3 can consist of the same compound recipe or of the same basic material, but having different compound recipes. It also is possible to use different materials, wherein e.g. the same basic material can be used with different qualities. The thicknesses of the two layers 2 and 3 e.g. can be as 60:40.

For a sheath M comprising two layers 2 and 3 as basis material e.g. Polyvinylchloride (PVC) is used, e.g. as follows:

| Layer 2 | |
|---|---|
| 37,4 | parts PVC with K-value 70 |
| 20,5 | parts plasticizer |
| 41,1 | parts chalk |
| 1 | part stabilizer. |
| Layer 3 | |
| 49,4 | parts PVC with K-value 70 |
| 24,6 | parts plasticizer |
| 24,6 | parts chalk |
| 1,2 | parts stabilizer |
| 0,2 | parts color. |

For the production of a cable according to FIGS. 1 or 2 after completion of the core 1 at least the layer 2 is applied to the same in an extruder with a chamber through which the core 1 is drawn. The used sheathing material can comprise a chemical additive for expansion of the material which forms the layer 2. To guarantee a homogeneous expansion of the sheathing material the agent for expansion can be added to the compound in a constant dosing flow. That can be achieved by using a corresponding dosing screw for dosing the agent into the sheathing material at the input of the extruder. The agent alternatively already can be added to the compound before filling the same into the extruder. The expansion of the sheathing material of layer 2 can be achieved also by gasinjection without a chemical additive. Gas then is blown into the molten sheathing material within the extruder. The expansion rate of the sheathing material can be from 5% to 50%. 10% to 20% is prefered.

Of influence to a constant rate of expansion of the sheathing material is the handling of the cable behind the extruder. The cable then is guided through a cooling system with a special volume of cooling water, depending on the dimensions of the respective cable. By using pressure reducing valves it is possible to keep the water volume at a constant value. The volume of the water can easily be controlled by use of a V-shaped cooling trough 8 according to FIG. 5. With such a trough 8 it also is possible to minimize the volume of cooling water, which is fed by or through a pipe 9, for higher speeds of the cable that is drawn through the trough without the danger of damaging the expanded sheathing material. After cooling the cable can be wound on a drum.

The layer 3 of the sheath M which is made of not expanded material can be applied in the same production step as the layer 2. That can be done by coextrusion in a common extrusion die. It is also possible to use a second extruder behind the first one and to apply the two layers 2 and 3 in tandem technique.

A sheath M in one layer 2 of FIG. 1 or two layers 2 and 3 of FIG. 2 is used with special advantages with house wiring cables as shown in FIGS. 3 and 4. Such cables are used with electrical voltages up to 1 kV. Normally they have two to five insulated wires which are stranded together and surrounded by a common sheath. House wiring cables also can comprise more than five insulated wires.

The cable of FIGS. 3 and 4 has three insulated wires 4, each with an insulation 5 surrounding a metallic conductor 6. The wires 4 normally are stranded with each other. The conductors 6 are made of copper. The insulation 5 can consist of Polyvinylchloride containing a plasticizer in the same manner as the sheath M. But again e.g. Polyethylene, Polypropylene or Polyurethane can be used. A filler 7 is applied for filling at least the interstices between the wires 4. The material of filler 7 e.g. can be a material on the basis of Polyvinylchloride, Rubber, EPDM (Ethylen Propylen Terpolymer) or POE (Poly Olefin Elastomer). The filler 7 consists e.g. for easy removal of a Polyolefin highly filled with chalk. It can extend over the wires 4. With its circular surface the filler 7 is a support for the sheath M which can be applied according to the method of FIG. 1 or FIG. 2.

For an additional reduction of weight and costs of the cable also the insulation of the wires within the core 1 of the cable in general and the filler 7 of the cable of FIGS. 3 and 4 can be made of expanded material. The expansion rate of the filler 7 can be from 10% to 80%. Again such an embodiment has special advantages with house wiring cables.

Instead of the electrical transmission elements of the described embodiments of the invention at least one optical waveguide can be comprised within the core 1 of the cable. The sheath of such an optical cable can be the same as described above for the sheath M.

According to the description above the sheath M comprises either one layer 2 or two layers 2 and 3. It also can comprise more than two layers. That is true also for the layer 2 of expanded insulating material alone, wherein different layers of the same e.g. can have different degrees of expansion.

1. A cable the core of which is surrounded by an external extruded sheath, which core comprises at least one transmission element for the transmission of electrical current or telecommunication signals, characterized in that the sheath (M) comprises at least one flexible layer (2) of a conventional, expanded material, this material having a tensile strength between 10.0 MPa and 50.0 MPa.

2. A cable according to claim 1, characterized in that the material of the sheath (M) is expanded by chemical additives.

3. A cable according to claim 1, characterized in that the material of the sheath (M) is expanded by gasinjection.

4. A cable according to one of the claims 1 to 3, characterized in that the degree of expansion of the sheathing material is 5% to 50%, preferably 10% to 20%.

5. A cable according to one of the claims 1 to 4, characterized in that the layer (2) of expanded material is surrounded by a layer (3) of not expanded material.

6. A cable according to claim 5, characterized in that the two layers (2,3) of the sheath (M) are consisting of the same compound recipe.

7. A cable according to claim 5, characterized in that the two layers (2,3) of the sheath (M) are consisting of the same basic material, but having different compound recipes.

8. A cable according to claim 5, characterized in that the two layers (2,3) of the sheath (M) are made of different basic materials.

9. A cable according to one of the claims 1 to 8, characterized in that the sheath (M) is made of Polyvinylchloride comprising a plasticizer.

10. A cable according to claim 9, characterized in that the layer (2) of expanded sheathing material comprises about 37.4 parts Polyvinylchloride with K-value 70, about 20.5 parts plasticizer, about 41.1 parts chalk and about 1 part stabilizer.

11. A cable according to claim 9, characterized in that the layer (3) of not expanded sheathing material comprises about 49.4 parts Polyvinylchloride with K-value 70, about 24.6 parts plasticizer, about 24.6 parts chalk, about 1.2 parts stabilizer and about 0.2 parts color.

12. A cable according to one of the claims 1 to 11, characterized in that the core (1) comprises at least two insulated wires (4) which together are surrounded by the sheath (M) of expanded sheathing material.

13. A cable according to claim 12, characterized in that the insulation of the wires (4) is expanded.

14. A cable according to one of the claims 1 to 11, characterized in that the core (1) comprises at least one optical waveguide.

15. Use of a cable according to one of the claims 1 to 13 with house wiring cables for electrical voltages up to 1 kV.

16. A method for the production of a cable with a core which is surrounded by an external extruded sheath, wherein within the core at least one transmission element for the transmission of electrical current or telecommunication signals is arranged, characterized in that a sheath (M) is extruded in at least one production step which comprises at least one flexible layer (2) of a conventional, expanded material with a tensile strength between 10.0 MPa and 50.0 MPa.

17. A method according to claim 16, characterized in that the material of the sheath (M) is expanded by chemical additives.

18. A method according to claim 17, characterized in that the chemical additives are dosed by a dosing screw into the sheathing material at the input of the extruder.

19. A method according to claim 17, characterized in that the chemical additives are given to the compound which is used as sheathing material before filling the same into the extruder.

20. A method according to claim 16, characterized in that the expansion of the sheathing material is achieved by gasinjection.

21. A method according to one of the claims 16 to 20, characterized in that the cable behind the extruder is cooled in a cooling system with a controlled volume of water.

22. A method according to claim 21, characterized in that the cable is guided through a V-shaped cooling trough (8).

23. A method according to one of the claims 16 to 22, characterized in that a layer (3) of not expanded material is formed around the layer (2) of expanded material.

24. A method according to claim 23, characterized in that the two layers (2,3) of the sheath (M) are applied in coextrusion technique.

25. A method according to claim 23, characterized in that the two layer (2,3) of the sheath (M) are applied in tandem technique.
